(19) United States
(12) Patent Application Publication
(10) Pub. No.: US 2021/0132439 A1
(43) Pub. Date: May 6, 2021

(54) BACKLIGHT

(71) Applicant: Samsung Display Co., Ltd., Yongin-Si (KR)

(72) Inventor: Sung Chul HONG, Yongin-si (KR)

(21) Appl. No.: 16/857,101

(22) Filed: Apr. 23, 2020

(30) Foreign Application Priority Data
Nov. 6, 2019 (KR) 10-2019-0141212

(51) Int. Cl. G02F 1/13357; G02F 1/1362

(52) U.S. Cl. CPC G02F 1/133602; G02F 2001/133612; G02F 1/136286

(57) ABSTRACT

A backlight may include: a light source board; a plurality of light source assemblies aligned on the light source board, each of the plurality of light source assemblies including light sources electrically connected to each other; a voltage supply line provided on the light source board, the voltage supply line configured to supply a driving voltage to the light source assemblies; and sensing lines provided on the light source board, the sensing lines configured to output a voltage detected from each of the light source assemblies. Each of the plurality of light source assemblies may include a connection electrode connecting the light sources. At least a portion of the connection electrode may be provided in a layer different from that of the sensing lines to overlap with the sensing lines.

### CROSS-REFERENCE TO RELATED APPLICATION

This application claims priority to and benefit of Korean patent application 10-2019-0141212 filed on Nov. 6, 2019 in the Korean Intellectual Property Office, the entire disclosure of the Korean Patent Application incorporated herein by reference.

### BACKGROUND

### 1. Field

The technical field generally relates to a backlight.

### 2. Related Art

As the field of information technology advances, the importance of display devices relaying information to users increases.

Accordingly, use of display devices such as a liquid crystal display device, an organic light emitting display device, and a plasma display device are increasing.

In a liquid crystal display device, light is emitted from light sources of a backlight, and transmittance of light is controlled in each pixel of a display panel to display an image frame.

### SUMMARY

Embodiments provide a backlight capable of decreasing its thickness and reducing heat generation.

In accordance with an aspect of the present disclosure, there is provided a backlight including: a light source board; a plurality of light source assemblies aligned on the light source board, each of the plurality of light source assemblies including light sources electrically connected to each other; a voltage supply line provided on the light source board, the voltage supply line configured to supply a driving voltage to the light source assemblies; and sensing lines provided on the light source board, the sensing lines configured to output a voltage detected from each of the light source assemblies, wherein each of the plurality of light source assemblies includes a connection electrode connecting the light sources, wherein at least a portion of the connection electrode is provided in a layer different from that of the sensing lines to overlap with the sensing lines.

The light sources included in each of the light source assemblies are include first to kth (k is an integer greater than 1) light sources connected in series to each other. The first light source may be connected to the voltage supply line, and the kth light source may be connected to one of the sensing lines.

The backlight may further include an insulating layer provided over the voltage supply line and the sensing lines. The connection electrode and the light sources may be provided on the insulating layer.

At least one of the light sources included in each of the light source assemblies may be connected, through a contact hole formed in the insulating layer, to at least one of the voltage supply line and the sensing lines.

Each of the light source assemblies may include: a first light source group including light sources spaced apart from each other along a first direction among the light sources; and a second light source group including light sources that are spaced apart from the first light source group in a second direction different from the first direction and spaced apart from each other along the first direction among the light sources.

The sensing lines may include at least one inner sensing line provided between the first light source group and the second light source group in the second direction.

The connection electrode may include a first connection electrode that connects one of the light sources included in the first light source group and one of the light sources included in the second light source group.

The first connection electrode may overlap with at least a portion of the at least one inner sensing line.

The connection electrode may include a second connection electrode that connects the light sources included in each of the first and second light source groups.

The second connection electrode may be provided in a same layer as the sensing lines.

The sensing lines may further include additional sensing lines facing the at least one sensing line with the second light source group interposed therebetween the additional sensing lines extending in the first direction.

The voltage supply line may face the at least one inner sensing line with the first light source group interposed therebetween, and extend in the first direction.

The backlight may further include a controller connected to the voltage supply line and the sensing lines, the controller configured to measure an output voltage transferred through the sensing lines, the controller configured to control a voltage applied to the voltage supply line based on the output voltage.

The sensing lines may include: a first sensing line connected to a first light source assembly; and a second sensing line connected to a second light source assembly. The first light source assembly may be located closer to the controller than the second light source assembly along the first direction. Based on the second direction different from the first direction, a width of the second sensing line may be greater than that of the first sensing line.

Each of the plurality of light source assemblies may include: a first contact electrode connecting the first light source and the voltage supply line; and a second contact electrode connecting the kth light source and one of the sensing lines.

The connection electrode may include at least one of indium tin oxide (ITO), indium zinc oxide (IZO), zinc oxide (ZnO), indium oxide (In₂O₃), indium gallium oxide (IGO), and aluminum zinc oxide (AZO).

In accordance with an aspect of the present disclosure, there is provided a display device including: a display panel; and a backlight, wherein the backlight includes: a light source board; a plurality of light source assemblies aligned on the light source board, each of the plurality of light source assemblies including light sources electrically connected to each other; a voltage supply line provided on the light source board, the voltage supply line configured to supply a driving voltage to the light source assemblies; and sensing lines provided on the light source board, the sensing lines configured to output a voltage detected from each of the light source assemblies, wherein each of the plurality of light source assemblies includes a connection electrode connecting the light sources, wherein at least a portion of the connection electrode is provided in a layer different from that of the sensing lines to overlap with the sensing lines.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein.

In the drawing figures, dimensions may be exaggerated for clarity of illustration. When an element is referred to as being “between” two elements, it can be the only element between the two elements, or one or more intervening elements may also be present.

Like reference numerals may refer to like elements throughout.

FIG. 1 is a sectional view illustrating a display device in accordance with an embodiment of the present disclosure.

FIG. 2 is a diagram illustrating a display panel in accordance with an embodiment of the present disclosure.

FIG. 3 is a diagram illustrating a pixel in accordance with an embodiment of the present disclosure.

FIG. 4 is a schematic plan view of a backlight in accordance with an embodiment of the present disclosure.

FIG. 5 is a plan view of a light source assembly in accordance with an embodiment of the present disclosure.

FIG. 6A is a sectional view taken along line I-I′ shown in FIG. 5.

FIG. 6B is a sectional view taken along line I-I′ shown in FIG. 5.

FIG. 7A is a sectional view taken along line II-II′ shown in FIG. 5.

FIG. 7B is a sectional view taken along line II-II′ shown in FIG. 5.

FIG. 8 is a plan view of a light source assembly in accordance with another embodiment of the present disclosure.

FIG. 9A is a sectional view taken along line III-III′ shown in FIG. 8.

FIG. 9B is a sectional view taken along line IV-IV′ shown in FIG. 8.

### DETAILED DESCRIPTION

In the drawings, the thickness of certain lines, layers, components, elements or features may be exaggerated for clarity. Although the terms “first”, “second”, etc. may be used herein to describe various elements, these elements should not be limited by these terms. These terms are only used to distinguish one element from another element. Thus, a “first” element discussed below could also be termed a “second” element without departing from the teachings of the present disclosure. As used herein, the singular forms are intended to include the plural forms as well, unless the context clearly indicates otherwise. The description of an element as a “first” element may not require or imply the presence of a second element or other elements. The terms “first,” “second,” etc. may be used to differentiate different categories or sets of elements. For conciseness, the terms “first,” “second,” etc. may represent “first-type (or first-set),” “second-type (or second-set),” etc., respectively.

The terms “includes” and/or “including”, when used in this specification, specify the presence of stated features, integers, steps, operations, elements, and/or components, but do not preclude the presence and/or addition of one or more other features, integers, steps, operations, elements, components, and/or groups thereof. Further, an expression that a first element such as a layer, region, substrate or plate is placed “on” or “above” a second element indicates not only a case where the first element is placed “directly on” the other second element but also a case where one or more intervening elements are interposed between the first element and the second element. An expression that an element such as a layer, region, substrate or plate is placed “beneath” or “below” another element indicates not only a case where the element is placed “directly beneath” the other element but also a case where a further element is interposed between the element and the other element.

Hereinafter, embodiments of the present disclosure will be described in detail with reference to the accompanying drawings.

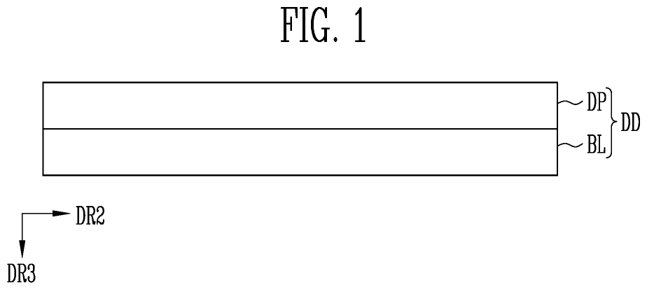

FIG. 1 is a sectional view illustrating a display device in accordance with an embodiment of the present disclosure.

Referring to FIG. 1, the display device DD in accordance with the embodiment of the present disclosure may include a display panel DP and a backlight BL.

The display device DD may be a liquid crystal display device or another kind of light transmissive display device. The display panel

DP may be a liquid crystal display panel or another kind of light transmissive display panel. A light transmissive display device means a display device in which at least some pixels of the display panel DP control transmittance of light emitted from the backlight BL to display an image. For example, at least some pixels of the display panel DP may not use the backlight BL as a light source, but may include a self-luminescent element.

The display panel DP may be located on the backlight BL. The display panel DP and the backlight BL may be provided in a plate shape having a plane extending in a first direction and a second direction DR2. In some embodiments, each of the display panel DP and the backlight BL may be provided in a plate shape with curvature to form a curved surface.

The display panel DP may be located in a third direction DR3 from the backlight BL. For convenience of description, the first direction DR1, the second direction DR2, and the third direction DR3 are described below as orthogonal to one another. In embodiments of the present disclosure, the directions may not be perpendicular to each other, but may be, for example, obtuse or acute with respect to at least some of the other directions.

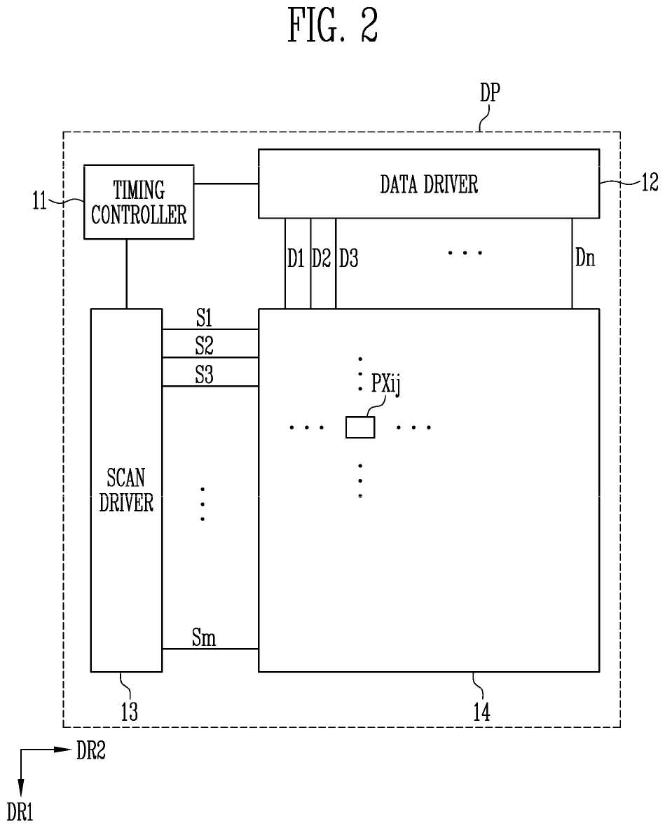

FIG. 2 is a diagram illustrating a display panel in accordance with an embodiment of the present disclosure.

Referring to FIG. 2, the display panel DP in accordance with the embodiment of the present disclosure may include a timing controller 11, a data driver 12, a scan driver 13, and a pixel unit 14.

The timing controller 11 may receive control signals and input grayscale values for an image frame from an external processor. The timing controller 11 may generate output grayscale values by compensating, regulating, or rendering the input grayscale values. The timing controller 11 may supply the output grayscale values and control signals to the data driver 12.

The data driver 12 may generate data voltages to be provided to data lines D1, D2, D3, through Dn by using the output grayscale values, the control signals, and the like. For example, data voltages generated in a unit of a pixel row (e.g., pixels connected to the same scan line) may be simultaneously applied to the data lines D1 to Dn.

In addition, the timing controller 11 may generate a clock signal, a scan start signal, to the scan driver 13, and supply the generated signals to the scan driver 13.

The scan driver 13 may generate scan signals to be provided to scan lines S1, S2, S3, through Sm by receiving the clock signal, the scan start signal, and the like from the timing controller 11. The scan driver 13 provides scan signals through the scan lines S1 to Sm to select pixels to which data voltages are to be written. For example, the scan driver 13 sequentially provides scan signals having a turn-on level to the scan lines S1 to Sm to select a pixel row to which data voltages are to be written. Stage circuits of the scan driver 13 may be configured in the form of shift registers, and generate scan signals in a manner that sequentially transfers the scan start signal to a next stage circuit under the control of the clock signal.

The pixel unit 14 includes a plurality of pixels. Each pixel PXij may be connected to a corresponding data line and a corresponding scan line. For example, when data voltages for one pixel row are applied to the data lines D1 to Dn from the data driver 12, the data voltages may be written to a pixel row on which a scan line supplied with the scan signal having the turn-on level from the scan driver 13 is located.

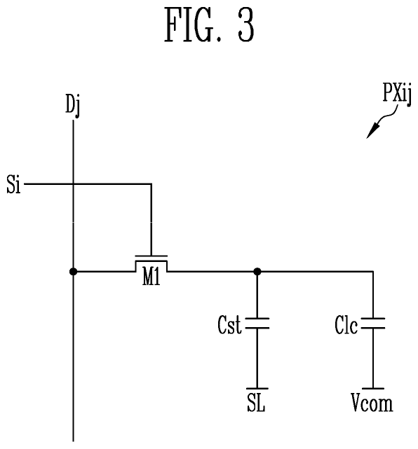

FIG. 3 is a diagram illustrating a pixel in accordance with an embodiment of the present disclosure.

Referring to FIG. 3, the pixel PXij included in the display panel DP may include a transistor M1, a storage capacitor Cst, and a liquid crystal capacitor Clc.

In this embodiment, the transistor M1 is illustrated as an N-type transistor, and therefore, a turn-on level of a scan signal may be a high level. A pixel circuit which performs the same function may be implemented by using a P-type transistor.

A gate electrode of the transistor M1 may be connected to a scan line Si, one electrode of the transistor M1 may be connected to a data line Dj, and the other electrode of the transistor M1 may be connected to one electrode of the storage capacitor Cst and a pixel electrode of the liquid crystal capacitor Clc.

The one electrode of the storage capacitor Cst may be connected to the other electrode of the transistor M1, and the other electrode of the storage capacitor Cst may be connected to a holding voltage line SL. In some embodiments, when the liquid crystal capacitor Clc has sufficient capacitance, the storage capacitor Cst may be excluded.

The pixel electrode of the liquid crystal capacitor Clc may be connected to the other electrode of the transistor M1, and a common voltage Vcom may be applied to a common electrode of the liquid crystal capacitor Clc. A liquid crystal layer may be located between the pixel electrode and the common electrode of the liquid crystal capacitor Clc. The common electrode may be an electrode shared by a plurality of pixels, e.g., all the pixels of the pixel unit 14. That is, the same common voltage may be applied the plurality of pixels sharing the common electrode.

When a scan signal having a turn-on level is supplied to the gate electrode of the transistor M1 through the scan line Si, the transistor M1 connects the data line Dj to the one electrode of the storage capacitor Cst. Therefore, a voltage corresponding to the difference between a data voltage applied through the data line Dj and a holding voltage of the holding voltage line SL is stored in the storage capacitor Cst. A data voltage applied to the pixel electrode of the liquid crystal capacitor Clc is held by the storage capacitor Cst. Therefore, an electric field corresponding to the difference between the data voltage and the common voltage is applied to the liquid crystal layer, and an orientation of liquid crystal molecules of the liquid crystal layer may be determined according to the electric field. Transmittance may correspond to the orientation of the liquid crystal molecules.

The display panel DP may further include a planarizing plate, a color filter, and the like.

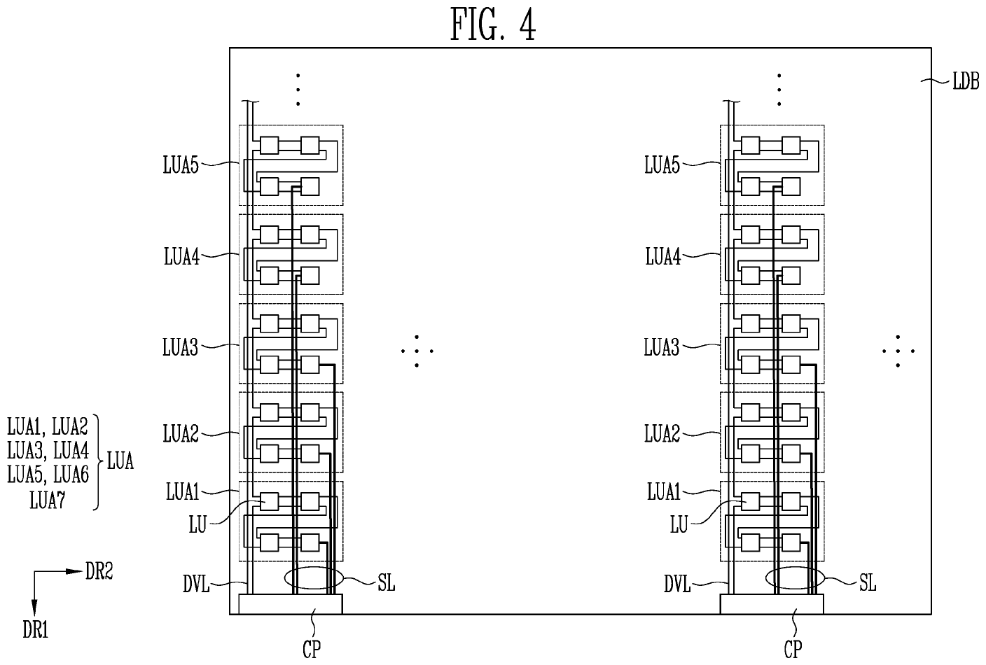

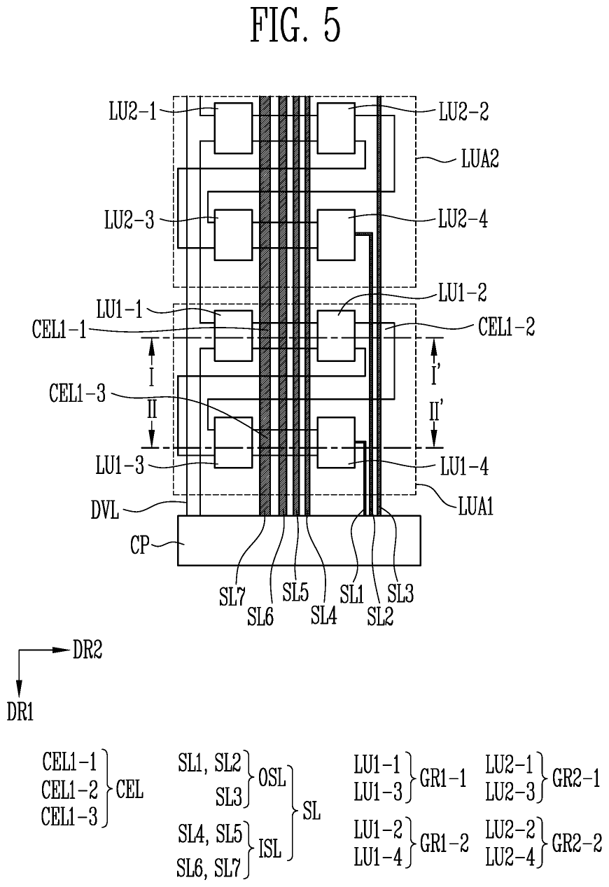

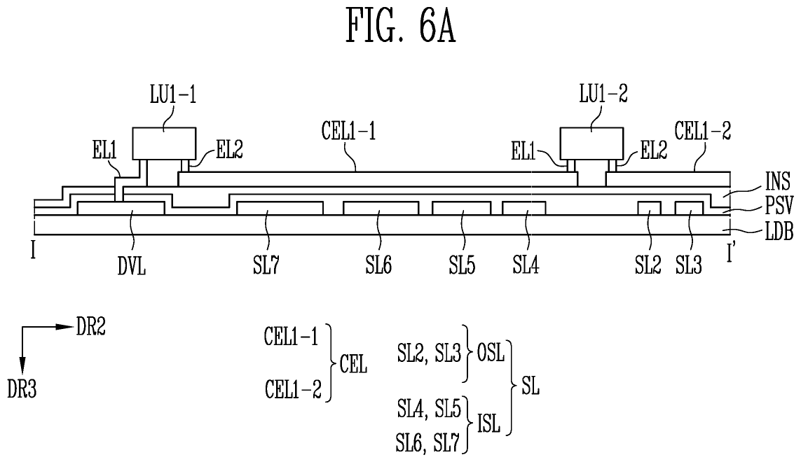

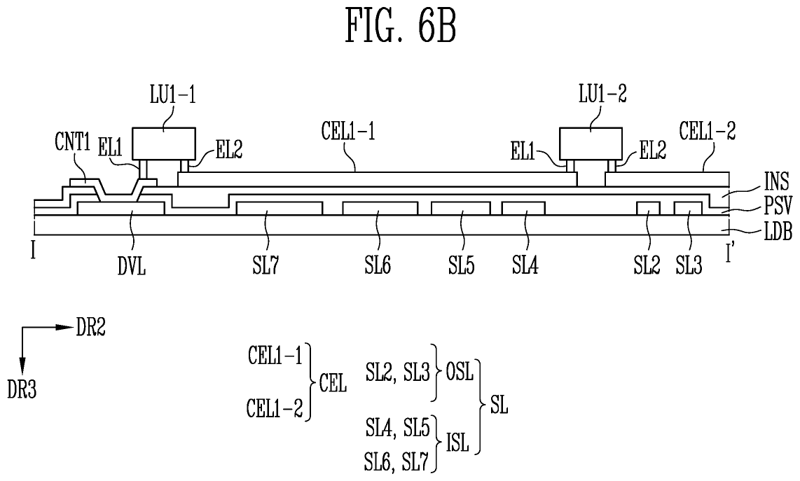

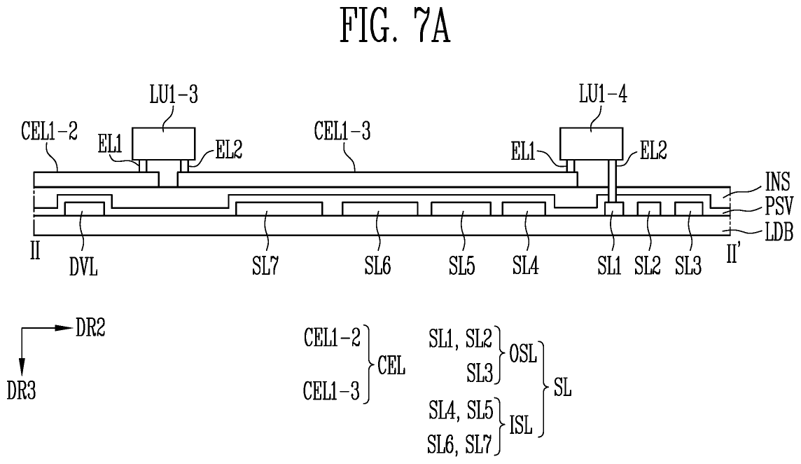

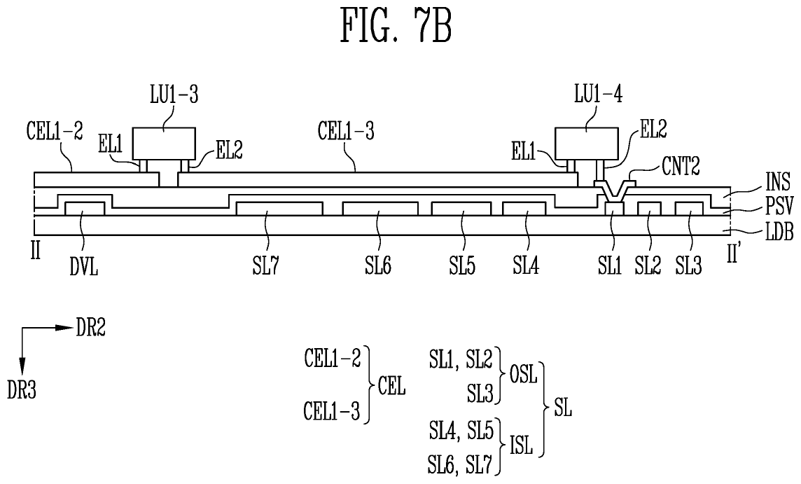

FIG. 4 is a schematic plan view of a backlight in accordance with an embodiment of the present disclosure. FIG. 5 is a plan view of a light source assembly in accordance with an embodiment of the present disclosure. FIGS. 6A and 6B are sectional views taken along line I-I′ shown in FIG. 5. FIGS. 7A and 7B are sectional views taken along line I-I′ shown in FIG. 5.

As shown in FIGS. 4 to 7B, the backlight BL in accordance with the embodiment of the present disclosure may include a light source board LDB, a plurality of light source assemblies LUA including light sources LU, a voltage supply line DVL, and sensing lines SL.

In an embodiment of the present disclosure, the light source board LDB may be an electric circuit such as a Printed Circuit Board (PCB) or a Flexible PCB (FPCB). In an embodiment, the light source board LDB may be a mount for supporting the light sources LU or be a heat sink for cooling the light sources LU.

Each of the light sources LU may be a Light Emitting Diode (LED), a Cold Cathode Fluorescent Lamp (CCFL), an External Electrode Fluorescent Lamp (EEFL), a Flat Fluorescent Lamp (FFL), or the like. When a driving voltage is supplied to the light sources LU through the voltage supply line DVL, the light sources LU may emit white light. When the light sources LU are provided with a separate color conversion layer or a separate color filter, the light sources LU may emit light of a color different from white.

In an embodiment of the present disclosure, the light source assemblies LUA including the light sources LU electrically connected to each other may be aligned on the light source board LDB, e.g., arranged in a column. As shown in FIG. 4, a plurality of light source assemblies LUA may be provided on the light source board LDB, and be arranged in a matrix form along columns extending in a first direction DR1 and rows extending in a second direction DR2 intersecting the first direction DR1.

In an embodiment of the present disclosure, each of the light source assemblies LUA may include a plurality of light sources LU electrically connected to each other. Although each of the light source assemblies LUA illustrated in FIGS. 4 to 7B includes four light sources LU electrically connected to each other, each of the light source assemblies LUA may include two, six, eight or ten light sources LU.

In addition, number of light sources LU included in the respective light source assemblies LUA may be equal to or different from one another. Although each of the light source assemblies LUA illustrated in FIGS. 4 to 7B includes four light sources LU is, a first light source assembly LUA1 may include four light sources LU, a second light source assembly LUA2 may include two light sources LU, and a third light source assembly LUA3 may include six light sources LU.

In an embodiment of the present disclosure, the voltage supply line DVL may be provided on the light source board LDB, and supply a driving voltage for driving the light sources LU included in each of the light source assemblies LUA. As shown in FIG. 4, the voltage supply line DVL may face a column of light source assemblies LUA extending in the first direction DR1.

In an embodiment of the present disclosure, the light sources LU included in each of the light source assemblies LUA may be connected in series. For example, each of the light source assemblies LUA may include first through kth (where k is an integer greater than 1) light sources LU connected in series to each other. First light sources LU1-1 and LU2-1 first in sequence among the light sources LU connected in series may be connected to the voltage supply line DVL. Referring to FIG. 5, a first light source LU1-1 included in the first light source assembly LUA1 may be connected to the voltage supply line DVL, to be applied with a driving voltage. The driving voltage applied to the first light source LU1-1 may be supplied, via second and third light sources LU1-2 and LU1-3, to a fourth light source LU1-4 that is last in sequence.

In addition, a first light source LU2-1 included in the second light source assembly LUA2 may be connected to the voltage supply line DVL to be applied with a driving voltage. The driving voltage applied to the first light source LU2-1 may be supplied, via second and third light sources LU2-2 and LU2-3, to a fourth light source LU2-4 that is last in sequence.

In an embodiment of the present disclosure, the sensing lines SL may be provided on the light source board LDB. The sensing lines SL may be provided in the same layer as the voltage supply line DVL on the light source board LDB. The sensing lines SL and the voltage supply line DVL may be provided on one surface of the light source board LDB, and extend along the first direction DR1.

The sensing lines SL may output a voltage detected from each of the light source assemblies LUA. For example, the sensing lines SL may be lines in which a balance voltage detected from the light source assemblies LUA flows. The sensing lines SL may be connected to the kth light source located last among the light sources LU connected in series.

Referring to FIG. 5, the fourth light source LU1-4 included in the first light source assembly LUA1 may be connected to a first sensing line SL1, and the fourth light source LU2-4 included in the second light source assembly LUA2 may be connected to a second sensing line SL2. Although not shown in FIG. 5, a third sensing line SL3 may be connected to a fourth light source included in the third light source assembly LUA3, a fourth sensing line SL4 may be connected to a fourth light source included in a fourth light source assembly LUA4, a fifth sensing line SL5 may be connected to a fourth light source included in a fifth light source assembly LUAS, a sixth sensing line SL6 may be connected to a fourth light source included in a sixth light source assembly LUA6, and a seventh sensing line SL7 may be connected to a fourth light source included in a seventh light source assembly.

In an embodiment of the present disclosure, the backlight BL may include a controller CP connected to the voltage supply line DVL and the sensing lines SL. A voltage detected from each of the light source assemblies LUA may be supplied to the controller CP through the sensing lines SL. The controller CP may measure an output voltage of the light source assemblies LUA, and control a voltage applied to the voltage supply line DVL, based on the measured output voltage.

For example, the controller CP may include a switching transistor. The controller CP may control an amount of current flowing in the voltage supply line DVL by controlling an on-duty of the switching transistor. The on-duty means a period of time for which the switching transistor is turned on.

When the balance voltage output from the light source assemblies LUA is lower than a reference voltage, the controller CP may decrease the on-duty of the switching transistor. Accordingly, the amount of current flowing in the voltage supply line DVL is increased, so that a driving voltage supplied to the light source assemblies LUA is increased. When the driving voltage supplied to the light source assemblies LUA is increased, the balance voltage output from the light source assemblies LUA is also increased.

When the balance voltage is higher than the reference voltage, the controller CP may increase the on-duty of the switching transistor. Accordingly, the amount of current flowing in the voltage supply line DVL is decreased, so that the driving voltage supplied to the light source assemblies LUA is decreased.

In this manner, the controller CP may control the amount of current applied to the light source assemblies LUA to be constant. That is, the controller CP may drive each of the light source assemblies LUA with a constant current.

In an embodiment of the present disclosure, each of the light source assemblies LUA may include a connection electrode CEL connecting the light sources LU. On the light source board LDB, at least a portion of the connection electrode CEL may be provided to overlap with the sensing lines SL in different layers. A portion of the connection electrode CEL and the sensing lines SL are provided to overlap with each other in different layers, so that a mounting space of the sensing lines SL on the light source board LDB can be further secured. In a comparative backlight, a connection electrode and sensing lines are provided in the same layer on a light source board, and therefore, it would be difficult to provide a mounting space of the sensing lines. On the other hand, in the backlight BL in accordance with the embodiment of the present disclosure, at least a portion of the connection electrode CEL overlaps with the sensing lines SL and is provided in a layer different from that of the sensing lines SL, so that a mounting space of the sensing lines SL can be further secured.

In an embodiment of the present disclosure, each of the light source assemblies LUA may include a first light source group GR1-1 or GR2-1 including light sources LU arranged to be spaced apart from each other along the first direction DR1, and second light source groups GR1-2 and GR2-2 respectively spaced apart from first light source groups GR1-1 and GR2-1 in the second direction DR2 different from the first direction DR1, the second light source groups GR1-2 and GR2-2 including light sources LU arranged to be spaced apart from each other along the first direction DR1.

Referring to FIG. 5, the first light source assembly LUA1 may include a first light source group GR1-1 including the first light source LU1-1 and the third light source LU1-3, and a second light source group GR1-2 including the second light source LU1-2 and the fourth light source LU1-4. Like the first light source assembly LUA1, the second light source assembly LUA2 may include a first light source group GR2-1 including the first light source LU2-1 and the third LU2-3, and a second light source group GR2-2 including the second light source LU2-2 and the fourth light source LU2-4.

In an embodiment of the present disclosure, an insulating layer INS may be provided over the voltage supply line DVL and the sensing lines SL, and the connection electrode CEL and the light sources LU may be provided on the insulating layer INS. The insulating layer INS may cover the voltage source line DVL and the sensing lines SL so that they are not exposed to the outside.

The insulating layer INS may include any one of an inorganic insulating material and an organic insulating material.

The inorganic insulating material may include at least one of metal oxides such as silicon oxide (SiOx), silicon nitride (SiNx), silicon oxynitride (SiON), and AlOx. The organic insulating material may include at least one of polyacrylates resin, epoxy resin, phenolic resin, polyamides resin, unsaturated polyesters resin, polyphenylenethers resin, polyphenylenesulfides resin, and benzocyclobutene resin.

In an embodiment of the present disclosure, the backlight BL may include a protective layer PSV provided on the light source board LDB. As shown in FIGS. 6A to 7B, the protective layer PSV may be provided on the one surface of the light source board LDB, and the insulating layer INS may be provided on the protective layer PSV. The protective layer PSV covers the voltage supply line DVL and the sensing lines SL so that they are not exposed to the outside, thereby preventing corrosion of the voltage supply line DVL and the sensing lines SL. The protective layer PSV may include any one of an inorganic insulating material and an organic insulating material. The protective layer PSV may be omitted according to process conditions.

In an embodiment of the present disclosure, the connection electrode CEL may include a (1-1)th to (1-3)th connection electrodes CEL1-1, CEL1-2, and CEL1-3 which connects one of the light sources LU included in the first light source group GR1-1 or GR2-1 and one of the light sources LU included in the second light source group GR1-2 or GR2-2. As shown in FIGS. 5 to 7B, the (1-1)th to (1-3)th connection electrodes CEL1-1, CEL1-2, and CEL1-3 may be provided on the insulating layer INS. Specifically, in the first light source assembly LUA1, a (1-1)th connection electrode CEL1-1 electrically connecting the first light source LU1-1 and the second light source LU1-2 may be provided on the insulating layer INS, a (1-2)th connection electrode CEL1-2 electrically connecting the second light source LU1-2 and the third light source LU1-3 may be provided on the insulating layer INS, and a (1-3)th connection electrode CEL1-3 electrically connecting the third light source LU1-3 and the fourth light source LU1-4 may be provided on the insulating layer INS.

In an embodiment of the present disclosure, at least one of the light sources LU included in each of the light source assemblies LUA may be connected to at least one of the voltage supply line DVL and the sensing lines SL through a contact hole formed in the insulating layer INS.

As shown in FIGS. 5 and 6A, in the first light source assembly LUA1, one electrode EL1 of the first light source LU1-1 may be connected to the voltage supply line DVL through a contact hole penetrating the insulating layer INS and the protective layer PSV. The other electrode EL2 of the first light source LU1-1 may be connected to the (1-1)th connection electrode CEL1-1 through a contact hole penetrating the insulating layer INS and the protective layer PSV. One electrode EL1 of the second light source LU1-2 may be connected to the (1-1)th connection electrode CEL1-1, and the other electrode EL2 of the second light source LU1-2 may be connected to the (1-2)th connection electrode CEL1-2. Accordingly, the first light source LU1-1 and the second light source LU1-2 may be electrically connected to each other.

As shown in FIGS. 5 and 7A, in the first light source assembly LUA1, one electrode EL1 of the third light source LU1-3 may be connected to the (1-2)th connection electrode CEL1-2, and the other electrode EL2 of the third light source LU1-3 may be connected to the (1-3)th connection electrode CEL1-3. Accordingly, the second light source LU1-2 and the third light source LU1-3 may be electrically connected to each other.

One electrode of the fourth light source LU1-4 may be connected to the (1-3)th connection electrode CEL1-3. The other electrode EL2 of the fourth light source LU1-4 may be connected to the first sensing line SL1 through a contact hole penetrating the insulating layer INS and the protective layer PSV. Since the first to fourth light sources LU1-1 to LU1-4 are electrically connected to each other, a driving voltage may be transferred to the first light source assembly LUA1 through the voltage supply line DVL, and a voltage detected from the first light source assembly LUA1 may be transferred to the first sensing line SL1.

In an embodiment of the present disclosure, each of the light source assemblies LUA may include a first contact electrode CNT1 which connects the first light source LU1-1 or LU2-1 located first among the light sources LU to the voltage supply line DVL, and a second contact electrode CNT2 which connects the kth light source located last to one of the sensing lines SL.

Referring to FIGS. 6B and 7B, the first contact electrode CNT1 may be provided in a through hole penetrating the insulating layer INS and the protective layer PSV. The first contact electrode CNT1 may be connected to the voltage supply line DVL, and the one electrode EL1 of the first light source LU1-1 may be connected to the first contact electrode CNT1. In addition, the second contact electrode CNT2 may be connected to the first sensing line SL through a through hole penetrating the insulating layer INS and the protective layer PSV, and the other electrode EL2 of the fourth light source LU1-4 may be connected to the second contact electrode CNT2. Through the first and second contact electrodes CNT1 and CNT2, the first and fourth light sources LU1-1 and LU1-4 can be stably connected to the voltage supply line DVL and the first sensing line SL1, respectively.

The first and second contact electrodes CNT1 and CNT2 may include at least one of various conductive materials such as ITO, IZO, and ITZO, and may thus be substantially transparent and/or translucent. However, the material of the first and second contact electrodes CNT1 and CNT2 is not so limited, and the first and second contact electrodes CNT1 and CNT2 may be made of various opaque conductive materials.

In an embodiment of the present disclosure, the connection electrode CEL may include at least one of indium tin oxide (ITO), indium zinc oxide (IZO), zinc oxide (ZnO), indium oxide (In₂O₃), indium gallium oxide (IGO), and aluminum zinc oxide (AZO). That is, the connection electrode CEL may be formed of at least one of ITO, IZO, ZnO, In₂O₃, IGO, and AZO. The voltage supply line DVL and the sensing lines SL may be formed of a metal. For example, the voltage supply line DVL and the sensing lines SL may be formed of an SD metal which is a metal forming the source or drain electrode of a transistor.

In an embodiment of the present disclosure, the sensing lines SL may include at least one inner sensing line ISL provided in the second direction DR2 between the first light source groups GR1-1 and GR2-1 and the second light source groups GR1-2 and GR2-2. Referring to FIG. 5, based on the second direction DR2, inner sensing lines ISL including fourth to seventh sensing lines SL4 to SL7 may be provided between the first light source groups GR1-1 and GR2-1 and the second light source groups GR1-2 and GR2-2.

As shown in FIGS. 4 to 7B, the voltage supply line DVL may face at least one inner sensing line ISL with the first light source groups GR1-1 and GR2-1 interposed therebetween, and extend in the first direction DR1.

In an embodiment of the present disclosure, the sensing lines SL may include additional sensing lines OSL which face at least one inner sensing line ISL with the second light source groups GR1-2 and GR2-2 interposed therebetween and extend in the first direction DR1. Referring to FIG. 5, based on the second direction DR2, the additional sensing lines OSL may be provided, which face the inner sensing lines ISL with the second light source groups GR1-2 and GR2-2 interposed therebetween and include the first to third sensing lines SL1 to SL3.

In an embodiment of the present disclosure, the first connection electrode CEL may overlap with a portion of at least one inner sensing line ISL. For example, the first connection electrode CEL, also referred to as the first connection electrode CEL1-1, CEL1-2, and CEL1-3, and the inner sensing lines ISL may be provided in different layers on the light source board LDB with the protective layer PSV and the insulating layer INS, which are interposed therebetween. In addition, a region of the light source board LDB, which overlaps with the first connection electrode CEL1-1, CEL1-2, and CEL1-3, may overlap with portions of the inner sensing lines ISL.

As shown in FIGS. 5 to 7B, the first connection electrode CEL, including (1-1)th to (1-3)th connection electrodes CEL1-1, CEL1-2, and CEL1-3, may overlap with the inner sensing lines ISL including the fourth to seventh sensing lines SL4 to SL7. In addition, a portion of the (1-2)th connection electrode CEL1-2 may be provided in a layer different from that of the additional sensing lines OSL including the second and third sensing lines SL2 and SL3 to overlap with the additional sensing lines OSL. Another portion of the (1-2)th connection electrode CEL1-2 may be provided in a layer different from that of the voltage supply line DVL to overlap with the voltage supply line DVL.

In the embodiment of the present disclosure, the connection electrode CEL is provided to overlap with the sensing lines SL, so that a mounting space of the sensing lines SL on the light source board LDB can be secured. Accordingly, sensing lines SL having a wider width can be provided on the light source board LDB, and the resistance of the sensing lines SL is decreased, so that heat generation can be suppressed in driving of the backlight BL. The backlight BL of which heat generation is suppressed in the driving of the backlight BL can be easily applied to large-sized display devices DD.

In an embodiment of the present disclosure, the sensing lines SL may include the first sensing line SL1 connected to the first light source assembly LUA1 and the second sensing line SL2 connected to the second light source assembly LUA2. The first light source assembly LUA1 may be located closer to the controller CP than the second light source assembly LUA2, and a width of the second sensing line SL2 may be greater than that of the first sensing line SL1 along the second direction DR2.

Referring to FIGS. 4 to 7B, a width of the third sensing line SL3 connecting the third light source assembly LUA3 and the controller CP may be greater than that of the second sensing line SL2. In addition, a width of the fourth sensing line SL4 connecting the fourth light source assembly LUA4 and the controller CP may be greater than that of the third sensing line SL3. A width of the fifth sensing line SL5 connected to the fifth light source assembly LUA5 may be lesser than a width of the sixth sensing line SL6 and a width of the seventh sensing line SL7.

As shown in FIG. 4, based on the first direction DR1, the first light source assembly LUA1 may be located closest in adjacency to the controller CP, and the fifth light source assembly LUA5 may be located farthest from the controller CP. Accordingly, a length of the second sensing lines SL2 connecting the second light source assembly LUA2 and the controller CP is longer than that of the first sensing line SL1 connecting the first light source assembly LUA1 and the controller CP. In addition, a length of the third sensing line SL3 connecting the third light source assembly LUA3 and the controller CP is longer than that of the second sensing line SL2 connecting the second light source assembly LUA2 and the controller CP. Lengths of the fourth to seventh sensing lines SL4 to SL7 may likewise be progressively longer from each other.

If the first to seventh sensing lines have the same width, the length of the seventh sensing line is longest, and hence the seventh sensing line has the greatest resistance among the first to seventh sensing lines. Therefore, the seventh sensing line would have the greatest amount of heat generation.

On the other hand, the backlight BL in accordance with the embodiment of the present disclosure can sufficiently secure a mounting space of the sensing lines SL on the light source board LDB.

Accordingly, the widths of the sensing lines SL can be increased in proportion to the lengths of the sensing lines SL connected to each of the light source assemblies LUA from the controller CP. The resistance of the sensing lines SL is decreased by sequentially increasing the widths of the first to seventh sensing lines SL1 to SL7, so that heat generated in the backlight BL can be suppressed.

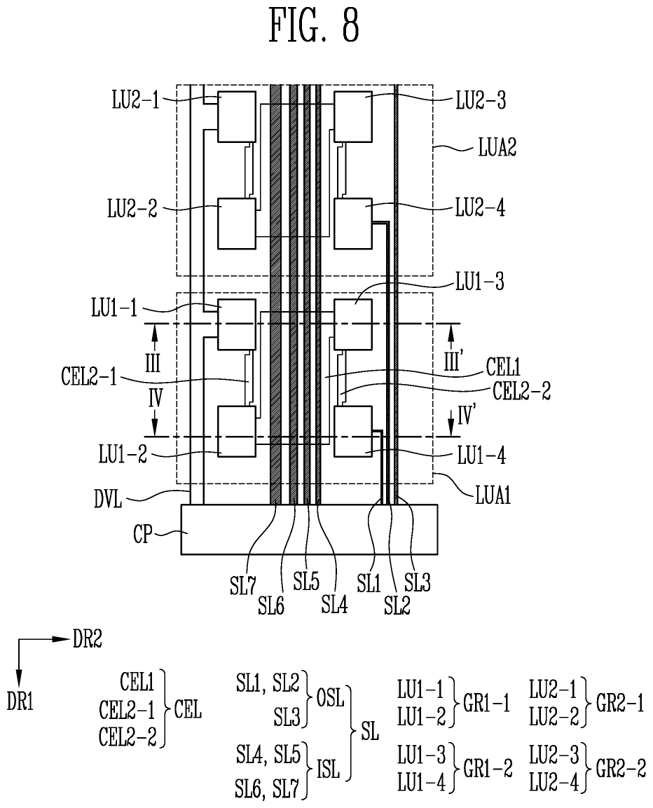

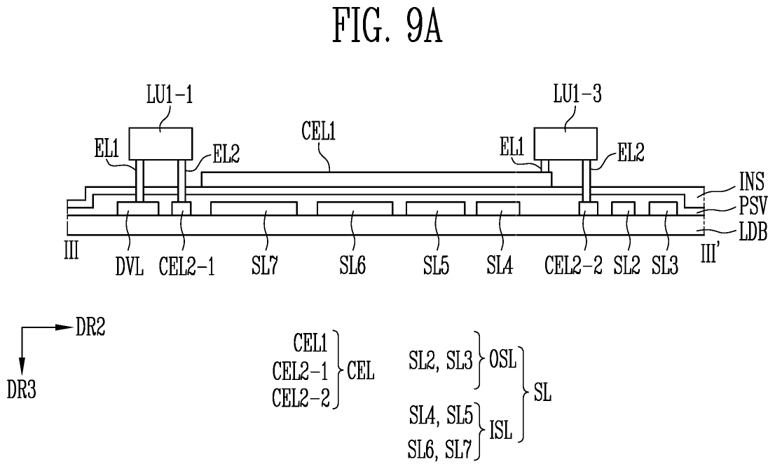

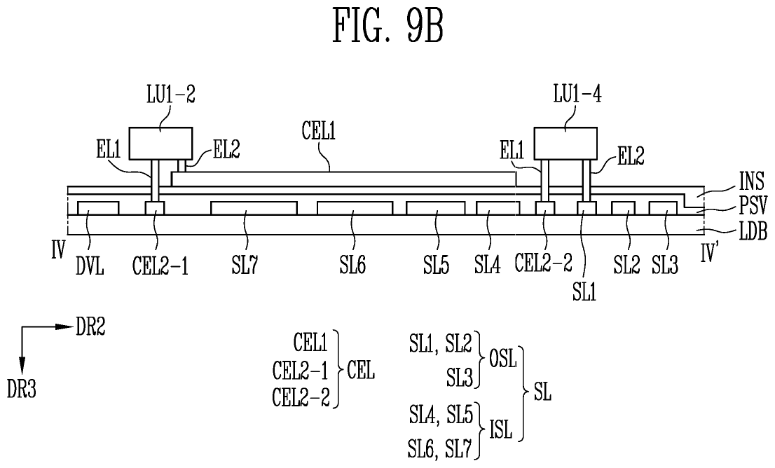

FIG. 8 is a plan view of a light source assembly LUA in accordance with another embodiment of the present disclosure. FIG. 9A is a sectional view taken along line III-III′ shown in FIG. 8 and FIG. 9B is a sectional view taken along line IV-IV′ shown in FIG. 8.

As shown in FIGS. 8 to 9B, the backlight BL in accordance with the embodiment of the present disclosure may include a light source board LDB, a plurality of light source assemblies LUA including light sources LU, a voltage supply line DVL, and sensing lines SL.

Referring to FIG. 8, a first light source assembly LUA1 may include a first light source group GR1-1 including a first light source LU1-1 and a second light source LU1-2, and a second light source group GR1-2 including a third light source LU1-3 and a fourth light source LU1-4. Like the first light source assembly LUA1, a second light source assembly LUA2 may include a first light source group GR2-1 including a first light source LU2-1 and a second light source LU2-2, and a second light source group GR2-2 including a third light source LU2-3 and a fourth light source LU2-4.

In an embodiment of the present disclosure, a connection electrode CEL may include a first connection electrode CEL1 which connects one of the light sources LU included in the first light source group GR1-1 or GR2-1 and one of the light sources LU included in the second light source group GR1-2 or GR2-2. In addition, the connection electrode CEL may include a second connection electrode CEL2-1 and CEL2-2, which connects the light sources LU included in each of the first light source group GR1-1 or GR2-1 and the second light source group GR1-2 or GR2-2.

As shown in FIG. 8, in the first light source assembly LUA1, the first light source LU1-1 and the second light source LU1-2, which are included in the first light source group GR1-1, may be connected to each other through a (2-1)th connection electrode CEL2-1, and the third light source LU1-3 and the fourth light source LU1-4, which are included in the second light source group GR1-2, may be connected through a (2-2)th connection electrode CEL2-2. The second light source LU1-2 included in the first light source group GR1-1 and the third light source LU1-3 included in the second light source group GR1-2 may be connected to each other through the first connection electrode CELL

In an embodiment of the present disclosure, the second connection electrode CEL2-1 and CEL2-2 may be provided in the same layer as the sensing lines SL. For example, the second connection electrode CEL2-1 and CEL2-2 may be provided together with the voltage supply line DVL and the sensing lines SL on one surface of the light source board LDB.

Referring to FIGS. 9A and 9B, one electrode EL1 of the first light source LU1-1 may be connected to the voltage supply line DVL through a contact hole penetrating an insulating layer INS and a protective layer PSV, and the other electrode EL2 of the first light source LU1-1 may be connected to the (2-1)th connection line CEL2-1 through a contact hole penetrating the insulating layer INS and the protective layer PSV. One electrode EL1 of the second light source LU1-2 may be connected to the (2-1)th connection line CEL2-1 through a contact hole penetrating the insulating layer INS and the protective layer PSV, and the other electrode EL2 may be connected to the first connection electrode CEL1 provided on the insulating layer INS. That is, the first light source LU1-1 and the second light source LU1-2, which are included in the first light source group GR1-1, may be connected to each other through the (2-1)th connection electrode CEL2-1.

One electrode EL1 of the third light source LU1-3 may be connected to the first connection electrode CEL1, and the other electrode EL2 of the third light source LU1-3 may be connected to the (2-2)th connection line CEL2-2 through a contact hole penetrating the insulating layer INS and the protective layer PSV. That is, the second light source LU1-2 included in the first light source group GR1-1 and the third light source LU1-3 included in the second light source group GR1-2 may be connected to each other through the first connection electrode CEL1.

One electrode EL1 of the fourth light source LU1-4 may be connected to the (2-2)th connection electrode CEL2-2 through a contact hole penetrating the insulating layer INS and the protective layer PSV, and the other electrode EL2 of the fourth light source LU1-4 may be connected to a first sensing line SL1 through a contact hole penetrating the insulating layer INS and the protective layer PSV. That is, the third light source LU1-3 and the fourth light source LU1-4, which are included in the second light source group GR1-2, may be connected to each other through the (2-2)th connection electrode CEL2-2.

The first to fourth light sources LU1-1 to LU1-4 may be electrically connected to each other, a driving voltage may be transferred to the first light source assembly LUA1 through the voltage supply line DVL, and a voltage output from the first light source assembly LUA1 may be transferred to the first sensing line SL1.

As shown in FIGS. 8 to 9B, the first connection electrode CEL1 may be provided in a layer different from that of the sensing lines SL, and inner sensing lines ISL may be provided to overlap with the first connection electrode CEL1. Accordingly, the backlight BL can further secure a mounting space of the sensing lines SL on the light source board LDB.

In accordance with the present disclosure, there can be provided a backlight capable of decreasing its thickness and reducing heat generation.

Further, in accordance with the present disclosure, the backlight can be easily applied to large-sized display devices.

Example embodiments have been disclosed herein, and although specific terms are employed, they are used for purpose of illustration. In some instances, as would be apparent to one of ordinary skill in the art in light of the the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present disclosure as set forth in the following claims.

What is claimed is:

1. A backlight comprising:
a light source board;
a plurality of light source assemblies aligned on the light source board, each of the plurality of light source assemblies including light sources electrically connected to each other;
a voltage supply line provided on the light source board, the voltage supply line configured to supply a driving voltage to the light source assemblies; and
sensing lines provided on the light source board, the sensing lines configured to output a voltage detected from each of the light source assemblies,
wherein each of the plurality of light source assemblies includes a connection electrode connecting the light sources, and
wherein at least a portion of the connection electrode is provided in a layer different from that of the sensing lines to overlap with the sensing lines.

2. The backlight of claim 1, wherein the light sources included in each of the light source assemblies are first to kth (k is an integer greater than 1) light sources connected in series to each other,
wherein the first light source is connected to the voltage supply line, and
the kth light source is connected to one of the sensing lines.

3. The backlight of claim 1, further comprising an insulating layer provided over the voltage supply line and the sensing lines,
wherein the connection electrode and the light sources are provided on the insulating layer.

4. The backlight of claim 3, wherein at least one of the light sources included in each of the light source assemblies is connected, through a contact hole formed in the insulating layer, to at least one of the voltage supply line and a sensing line among the sensing lines.

5. The backlight of claim 1, wherein each of the light source assemblies includes:
a first light source group including light sources spaced apart from each other along a first direction among the light sources; and
a second light source group including light sources that are spaced apart from the first light source group in a second direction different from the first direction and spaced apart from each other along the first direction among the light sources.

6. The backlight of claim 5, wherein the sensing lines include at least one inner sensing line provided between the first light source group and the second light source group in the second direction.

7. The backlight of claim 6, wherein the connection electrode includes a first connection electrode that connects one of the light sources included in the first light source group and one of the light sources included in the second light source group.

8. The backlight of claim 7, wherein the first connection electrode overlaps with at least a portion of the at least one inner sensing line.

9. The backlight of claim 5, wherein the connection electrode includes a second connection electrode that connects the light sources included in each of the first and second light source groups.

10. The backlight of claim 9, wherein the second connection electrode is provided in a same layer as the sensing lines.

11. The backlight of claim 6, wherein the sensing lines further include additional sensing lines facing the at least one sensing line with the second light source group interposed therebetween, the additional sensing lines extending in the first direction.

12. The backlight of claim 6, wherein the voltage supply line faces the at least one inner sensing line with the first light source group interposed therebetween and extends in the first direction.

13. The backlight of claim 1, further comprising a controller connected to the voltage supply line and the sensing lines, the controller configured to measure an output voltage transferred through the sensing lines and control a voltage applied to the voltage supply line based on the output voltage.

14. The backlight of claim 13, wherein the sensing lines include:
a first sensing line connected to a first light source assembly; and
a second sensing line connected to a second light source assembly,
wherein the first light source assembly is located closer to the controller than the second light source assembly along the first direction, and
wherein, based on the second direction different from the first direction, a width of the second sensing line is greater than that of the first sensing line.

15. The backlight of claim 2, wherein each of the plurality of light source assemblies includes:
a first contact electrode connecting the first light source and the voltage supply line; and
a second contact electrode connecting the kth light source and one of the sensing lines.

16. The backlight of claim 1, wherein the connection electrode includes at least one of indium tin oxide (ITO), indium zinc oxide (IZO), zinc oxide (ZnO), indium oxide (In₂O₃), indium gallium oxide (IGO), and aluminum zinc oxide (AZO).

17. A display device comprising:
a display panel; and
a backlight,
wherein the backlight includes:
a light source board;
a plurality of light source assemblies aligned on the light source board, each of the plurality of light source assemblies including light sources electrically connected to each other;
a voltage supply line provided on the light source board, the voltage supply line configured to supply a driving voltage to the light source assemblies; and
sensing lines provided on the light source board, the sensing lines configured to output a voltage detected from each of the light source assemblies,
wherein each of the plurality of light source assemblies includes a connection electrode connecting the light sources, and
wherein at least a portion of the connection electrode is provided in a layer different from that of the sensing lines to overlap with the sensing lines.
